(19) United States
(12) Patent Application Publication
(10) Pub. No.: US 2008/0179806 A1
(43) Pub. Date: Jul. 31, 2008

(54) TERMINAL CONNECTOR CATCH JIG, TERMINAL CONNECTOR FIXING METHOD, AND WIRE HARNESS ASSEMBLING METHOD

(75) Inventor: Tadashi Ikezawa, Inukami-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignees: The Furukawa Electric Co, Ltd., Chiyoda-Ku (JP); Furukawa Automotive Systems Inc., Inukami-gun (JP)

(21) Appl. No.: 11/943,217

(22) Filed: Nov. 20, 2007

(30) Foreign Application Priority Data
Jan. 29, 2007 (JP) 2007-018320

(51) Int. Cl. H01B 13/012

(52) U.S. Cl. 269/296; 29/868

(57) ABSTRACT

A terminal connector catch jig to fix a terminal connector included in a wire harness terminal. On a placing table on which the terminal connector is set, in opposition to a connection surface of a wire in the terminal connector, a comb-teeth portion constituted by a plurality of rod-like members uprightly arranged at intervals in each of which the wire can be inserted and a connector fixing portion which holds and fixes the terminal connector between the comb-teeth portion and the connector fixing portion are arranged.

### BACKGROUND OF THE INVENTION

1. Field of the Invention

The present invention relates to a terminal connector catch jig for fixing a connector which is included in a wire harness terminal when a wire harness constituted by a plurality of wires is assembled.

More specifically, the present invention provides an inexpensive terminal connector catch jig which, during assembling of a wire harness, accurately fixes a connector (called a terminal connector) included in a wire harness terminal, from which the terminal connector can be easily removed, and which has high versatility suitable for terminal connectors having various sizes, a terminal connector fixing method using the terminal connector catch jig, and a wire harness assembling method.

2. Description of the Related Art

In assembling a wire harness, it is desired to accurately fix a terminal connector as needed which is arranged on the terminal in order to position a wire harness terminal.

The terminal connector is usually fixed by use of a jig called a terminal connector catch jig. Conventionally, terminal connector catch jigs typically shown in FIGS. 8 and 9 have been used.

In a terminal connector catch jig 100 shown in FIG. 8, positional accuracy is high because a resin frame 101 catches the terminal connector 102 to regulate its position and fix the terminal connector 102 at the position. However, since the jig itself corresponds to each terminal connector, when different terminal connectors are used, jigs must be changed depending on every terminal connector. As a result, the cost increases and a very large number of steps must be disadvantageously carried out in development design and manufacturing.

On the other hand, in a terminal connector catch jig 110 shown in FIG. 9, a leading end holding jig 111a and a U-shaped jig 111b which holds a terminal connector 112 need to be prepared and a step for attaching the leading end holding jig 111a and the U-shaped jig 111b to a jig board (not shown) must be additionally carried out. Furthermore, an attaching hole for the leading end holding jig must be set because a position of the leading end holding jig changes depending on every terminal connector to be used. Therefore, the number of steps disadvantageously increases.

In this surroundings, improved terminal connector catch jig described in Patent Document 1 and Patent Document 2 are proposed.

In the Patent Document 1, as shown in FIG. 10, a terminal connector C is arranged on a U-shaped upright portion 151 extending from a temporary-fixing portion 150 first, and is fixed by a terminal connector fastening member 152 which is arranged around a terminal connector C. In FIG. 10, reference symbol W denotes a branch electric wire, and reference symbol L denotes a branch size.

In the Patent Document 2, as shown in FIG. 11, U-shaped rods 51A and 51B penetrate through one pair of holes 60A-3 and 60B-3 provided at positions of a size management table 200. The holes of the size management table 200 are provided corresponding to various sizes of terminal connectors. A terminal connector 56 is arranged and fixed between a wall plate 61 and the U-shaped rods 51A and 51B. This jig can cope with several sizes.

[Patent Document 1] Japanese Unexamined Patent Publication No. 10-106369

[Patent Document 2] Japanese Unexamined Patent Publication No. 11-213782

However, the proposal in Patent Document 1 requires two operation procedures to fix the terminal connector C. That is, as shown in FIG. 10, firstly the terminal connector C is arranged on the U-shaped upright portion 151 which extends from the temporary-fixing portion 150. Secondly, one end of the terminal connector fastening member 152, which serves as a fixing portion 155 and is arranged on the base portion 153, is largely stretched and is wound around the terminal connector C and hooked to the leading end of the U-shaped upright portion 151 as a fastening portion 154 so as to fix the terminal connector C.

In the proposal in Patent Document 2, when a terminal connector is changed into another terminal connector having a different size, the U-shaped rods 51A and 51B need to be again penetrated through another pair of holes 60A-3 and 60B-3 of the size management table 200 which are suitable for the size of the changed terminal connector. Therefore, additional operation procedures are inevitably performed, which deteriorates operation efficiency.

### SUMMARY OF THE INVENTION

The present invention has been made in consideration of the circumstances, and has as its object to provide a terminal connector catch jig which, during assembling of a wire harness, can easily fix and remove a terminal connector for the wire harness, a terminal connector fixing method, and a wire harness assembling method.

In order to achieve the above object, the invention according to a first aspect is characterized that a terminal connector catch jig to fix a terminal connector included in a wire harness terminal comprises a comb-teeth portion and a connector fixing portion, wherein, the comb-teeth portion is arranged on a placing table for the terminal connector and in opposition to a connection surface of a wire in the terminal connector, and the comb-teeth portion is constituted by a plurality of rod-like members witch are uprightly arranged at intervals in each of which the wire can be inserted, and the connector fixing portion fixes the terminal connector by holding the terminal connector with the comb-teeth.

In the present invention according to a second aspect, in addition to the object of the first aspect, the comb-teeth portion and the connector fixing portion are integrally formed on the placing table in order to improve rigidity of the terminal connector catch jig.

In the present invention according to a third aspect, in addition to the object of the first and the second aspects, the connector fixing portion has a configuration where an elastic member which elastically presses the terminal connector on the placing table to a comb-teeth portion side in order to perform more reliable holding and fixing of the terminal connector.

In the present invention according to a fourth aspect, in addition to the object of any one of the first to third aspects, in order to simplify the elastic member in configuration, the elastic member is an inverted-U-shaped curved portion.

In the present invention according to the fifth aspect, in addition to the object of any one of the previous aspects, in order to prevent displacement in bundling of a wire harness and stress acting on the wire due to horizontal misalignment of the terminal connector on the placing table, a regulating portion which regulates lateral misalignments of the terminal connector on the placing plate with respect to the comb-teeth portion is arranged on the placing table.

In the present invention according to a sixth aspect, in addition to the object of any one of previous aspects, in order to improve assembling efficiency of the wire harness not causing disturbance in an operation by a single wire, a wire temporary-fixing portion which can temporary fix one wire or a plurality of wires is arranged in or adjacent to the comb-teeth portion.

In the present invention according to a seventh aspect, in addition to the object of the sixth aspect, the wire temporary-fixing portion is attachably and detachably arranged in order to use the wire temporary-fixing portion only when it is necessary.

In the present invention according to a eighth aspect, in addition to the object of the sixth and the seventh aspects, in order to easily carry out temporarily fixing and removing a wire from the wire temporary-fixing portion, the wire temporary-fixing portion is constituted by a plurality of temporary-fixing pins uprightly disposed in parallel to the rod-like members of the comb-teeth portion and an elastic roller externally covered on one of the temporary-fixing pins or the plurality of temporary-fixing pins to temporarily fix the wire such that the wire is elastically held between the temporary-fixing pin and the elastic roller or between the plurality of elastic rollers.

In order to achieve the above objects, the present invention according to a ninth aspect provides a terminal connector fixing method wherein, in the terminal connector catch jig of any one of the previous aspects, a terminal connector included in a wire harness terminal is arranged between a comb-teeth portion and a connector fixing portion from above a placing plate in a state where a connection surface of a wire faces a comb-teeth portion side, so that the terminal connector is hold between the comb-teeth portion and the connector fixing portion.

In order to achieve the objects, the present invention according to a tenth aspect provides a method which fixes a terminal connector included in a wire harness terminal to regulate a wire harness position and assembles the wire harness, wherein, in the terminal connector catch jig of any one of the previous aspects, a terminal connector is arranged between a comb-teeth portion and a connector fixing portion from above a placing plate in a state where a connection surface of a wire faces a comb-teeth portion side, and the terminal connector is hold and fixed between the comb-teeth portion and the connector fixing portion to regulate a position of the wire harness.

According to the present invention, a terminal connector included in the terminal of the wire harness can be easily and accurately attached, fixed, and removed, and the terminal connector catch jig can cope with various sized terminal connectors without increasing the number of production steps. Therefore, the terminal connector catch jig has excellent versatility, and is conspicuously effective to improve production efficiency in harness assembling steps and to reduce the production cost.

According to the second aspect of the present invention, in addition to the effect of the first aspect, the rigidity of the terminal connector catch jig can be improved.

According to the third aspect of the present invention, in addition to the effect of the first and second aspects, the terminal connector can be more reliably held and fixed.

According to the fourth aspect of the present invention, in addition to the effect of any one of the first to the third aspects, the elastic member can be easily constructed.

According to the fifth aspect of the present invention, in addition to the effect of any one of the previous aspects, displacement in bundling of the wire harness or stress on the wire caused by a horizontal misalignment of the terminal connector on the placing table can be prevented by the regulating portion.

According to the present invention of the sixth aspect, in addition to the effect of any one of the previous aspects, assembling efficiency of the wire harness can be improved by employing the wire temporary-fixing portion, not causing disturbance by a single wire in the operation

According to the present invention of the seventh aspect, in addition to the effect of the sixth aspect, the wire temporary-fixing portion can be used only when needed, which improves the usability.

According to the present invention of the eighth aspect, in addition to the effect of the sixth or seventh aspect, a wire can be easily temporarily fixed and removed.

### DESCRIPTION OF THE DRAWINGS

FIGS. 1A and 1B are perspective views according to a first embodiment, in which FIG. 1A shows an entire terminal connector catch jig and FIG. 1B shows only a placing table.

FIG. 2 is an explanatory diagram for methods of attaching and fixing a terminal connector to the terminal connector catch jig.

FIG. 3 is a perspective view according to a second embodiment.

FIG. 4 is a perspective view according to a third embodiment.

FIG. 5 is a sectional view showing a modification example of a connector fixing portion according to a fourth embodiment.

FIG. 6 is a perspective view according to a fifth embodiment.

FIG. 7 is a plan view of a terminal connector catch jig.

FIG. 8 is a perspective view of a conventional terminal connector catch jig.

FIG. 9 is a perspective view of a conventional terminal connector catch jig.

FIG. 10 corresponds to FIG. 1 of Patent Document 1.

FIG. 11 corresponds to FIG. 5 of Patent Document 2.

### DETAILED DESCRIPTION OF THE PREFERRED EMBODIMENTS

Embodiments of the present invention will be described below with reference to the accompanying drawings.

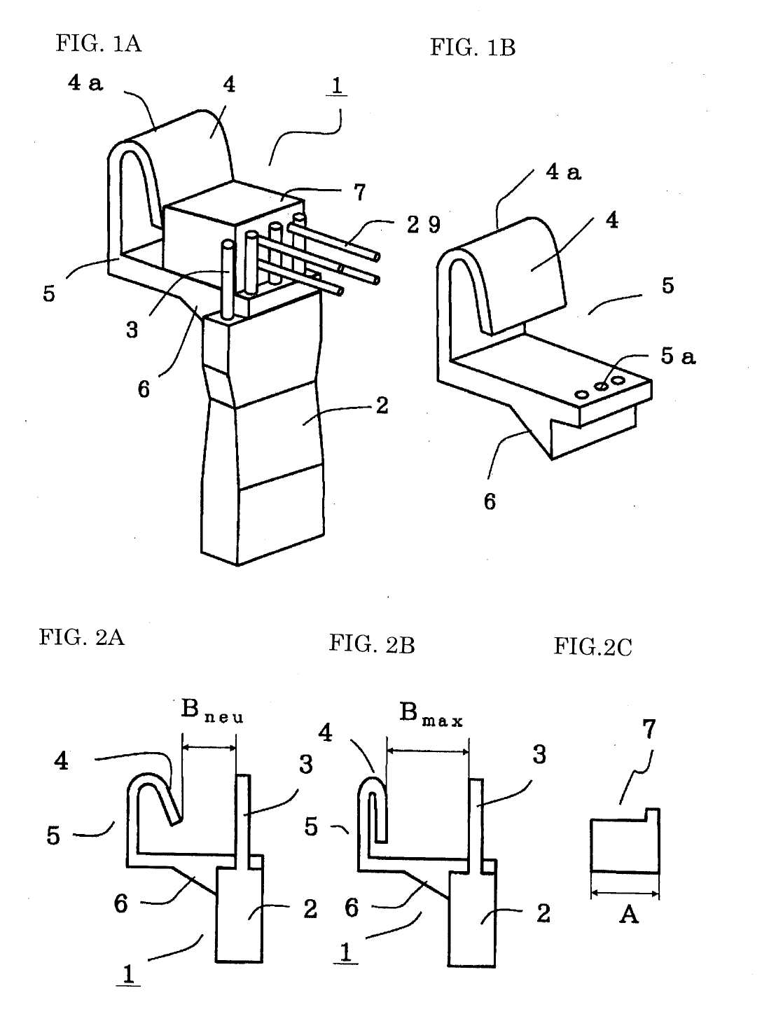

FIG. 1A and FIG. 1B are perspective views of a terminal connector catch jig according to a first embodiment, in which FIG. 1A is an overall diagram and FIG. 1B shows a placing table. Reference numeral 1 denotes a terminal connector catch jig according to the first embodiment; 2, a support table; 3, comb-teeth portion; 4, a connector fixing portion having an inverted U-shaped curved portion 4a to achieve spring characteristics; 5, a placing table; 5a, an attaching hole in which the comb-teeth portion 3 is to be fitted; 6, a warp-proof rib for the placing table 5; 7, a terminal connector; and 29, a wire.

In FIG. 1A and FIG. 1B, the terminal connector catch jig 1 is constituted by the support table 2 including the comb-teeth portion 3 which has a plurality of rod-like members upright formed upwardly, and the placing table 5 including the connector fixing portion 4 having the inverted U-shaped curved portion 4a at one end portion, serving as an elastic member. The comb-teeth portion 3 is inserted into the attaching hole 5a formed in the other end portion of the placing table 5, and the comb-teeth portion 3 is fitted in the attaching hole 5a to integrate the support table 2 and the placing table 5 with each other. Reference numeral 6 denotes a warp-proof rib formed on a lower surface of the placing table 5. The deflection-proof rib 6 is brought into contact with a rear surface of the support table 2 in a state where the support table 2 and the placing table 5 are assembled, so that downward deflection of the placing table 5 is prevented.

In this manner, the terminal connector catch jig 1 has a structure obtained by combining the support table 2 and the placing table 5 to prepare a plurality of placing plates 5 corresponding to the size of the terminal connector. Thereby, an optimum placing table 5 can be arbitrarily selected corresponding to the terminal connector 7, and the terminal connector catch jig can cope with the various sizes of terminal connectors 7 in a wide range.

A method of attaching, fixing, and removing the terminal connector 7 to/from the terminal connector catch jig 1 will be described below.

FIGS. 2A to 2C are explanatory diagrams related to fixation of the terminal connector of the terminal connector catch jig in the embodiment of the present invention. As shown in FIG. 2C, a length of the terminal connector 7 is represented by A, a natural length in an interval B between the comb-teeth portion 3 and the connector fixing portion 4 is represented by Bₙₑᵤ (FIG. 2A), and the maximum length is represented by Bₘₐₓ (FIG. 2B). In this case, a relationship between the terminal connector 7 and the terminal connector catch jig 1 is set to satisfy Bₘₐₓ>A≧Bₙₑᵤ.

In the attachment and fixation of the terminal connector 7, under the condition given by Bₘₐₓ>A≧Bₙₑᵤ, the terminal connector 7 is inserted into the placing table 5 of the wire terminal connector catch jig 1 from above in a state where the connection side of the wire 29 faces the comb-teeth portion 3 side. In this case, the wire 29 is held by the comb-teeth portion 3, and an interval between the comb-teeth portion 3 and the connector fixing portion 4 gradually increases by the spring characteristics of the connector fixing portion 4. When the interval B is changed from the natural length Bₙₑᵤ to reach a length (almost equal to A) for fixing the terminal connector 7, the terminal connector 7 is hold between the connector fixing portion 4 and the comb-teeth portion 3 and fixed at a predetermined position using the comb-teeth portion 3 as a reference point. In this manner, the terminal connector 7 is held between the connector fixing portion 4 and the comb-teeth portion 3 by the spring characteristics of the connector fixing portion 4 and the terminal connector is firmly fixed.

On the other hand, in the removal (detachment) of the terminal connector 7, when the terminal connector 7 is removed upwardly, the interval B between the comb-teeth portion 3 and the connector fixing portion 4 becomes larger than the length A of the terminal connector 7. As a result, the terminal connector 7 can be easily removed.

As the method related to the attachment, fixation, and removal of the terminal connector is common in all the embodiments of the present invention, improvement of production efficiency and a reduction in production cost in the wire harness assembling step can be realized.

That is, in a step of wire harness assembling, the terminal connector is pressed on the comb-teeth portion disposed on the support table fixed to a jig board by the spring characteristics of the connector fixing unit, so that positional regulation of the wire harness terminal can be accurately and easily performed. Further, attachment, fixation, and removal of the terminal connector can be easily performed by one action by means of the spring characteristics.

Furthermore, since the interval B between the comb-teeth portion and the connector fixing unit is variable, attachment and fixation of various terminal connectors having different lengths can be performed without exchanging jigs. Therefore, the operation efficiency is not deteriorated, and one terminal connector catch jig can cope with a plurality of types of terminal connectors to contribute to a reduction of production cost.

In this manner, according to the terminal connector, the fixing method for the terminal connector catch jig in the above embodiment and the wire harness assembling method, the terminal connector 7 can be easily and accurately attached, fixed, and removed. Further, the terminal connector catch jig can cope with various sizes of the terminal connectors 7 without increasing the number of production steps. Therefore, the terminal connector catch jig has excellent versatility, and is conspicuously effective to improve production efficiency of harness assembling steps and to reduce the production cost.

In this case, since the connector fixing portion 4 includes an elastic member (inverted-U-shaped curved portion 4a) which elastically presses the terminal connector 7 on the placing table 5 to the comb-teeth portion 3 side, the terminal connector 7 can be reliably held and fixed. In particular, the inverted U-shaped curved portion 4a is used as the elastic member to simply construct the elastic member.

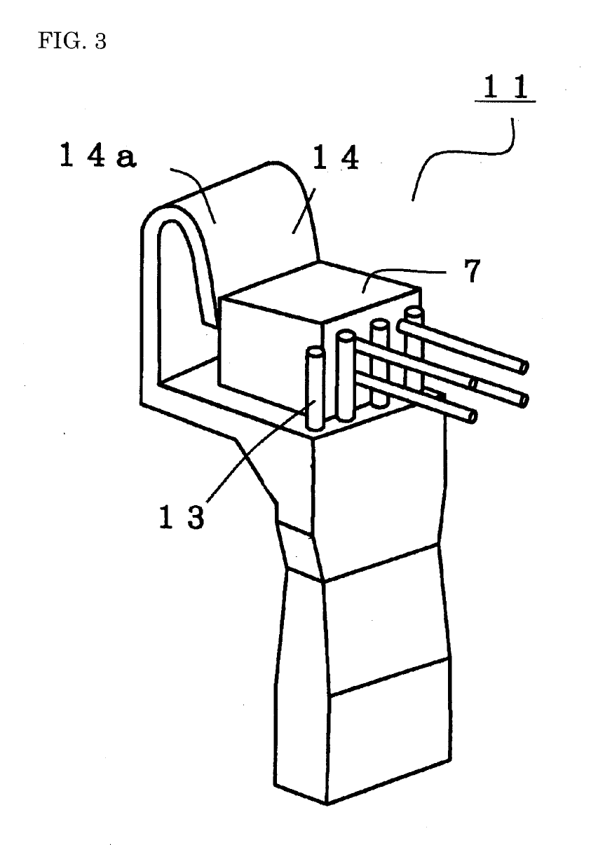

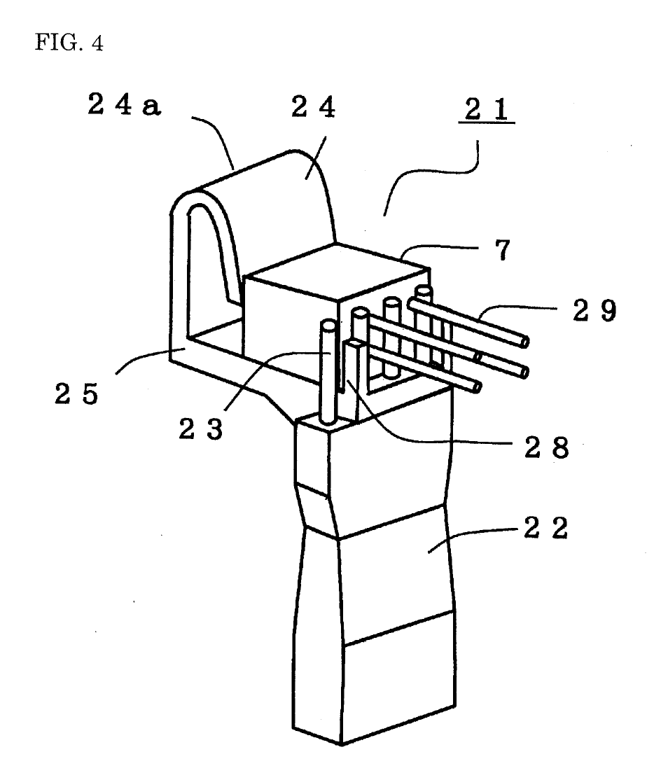

In a second embodiment shown in FIG. 3, the support table 2 and the placing table 5 according to the first embodiment are integrally formed.

In FIG. 3, reference numeral 11 denotes a terminal connector catch jig; 13, a comb-teeth portion; 14, a connector fixing portion; and 14a, an inverted-U-shaped curved portion having spring characteristics. In the second embodiment, the support table 2 and the placing table 5 are integrally formed, so that the fitting portion as used in the first embodiment is not arranged. For this reason, a terminal connector catch jig having very high rigidity can be obtained.

In the second embodiment, the terminal connector catch jig cannot cope with terminal connectors having different sizes in a wide range as in the first embodiment. However, by the method related to attachment, fixation, and removal of the terminal connector, the terminal connector catch jig can cope with terminal connectors in a certain range and has versatility.

FIG. 4 is a perspective diagram of a terminal connector catch jig 21 according to a third embodiment. In the terminal connector catch jig 21, reference numeral 22 denotes a support table; 23, a comb-teeth portion; 24, a connector fixing portion; 24a, an inverted-U-shaped curved portion; and 25, a placing table. In this case, a wall is raised on an end portion of the placing table 25 from a side surface, and a wire temporary-fixing portion 28 is arranged at an outermost position in the comb-teeth portion 23. Reference numeral 29 denotes a wire.

That is, when some wires are not connected to the terminal connector 7, insulating-coated parts of the disconnected wires are inserted from above between the wire temporary-fixing portion 28 and the outermost rod-like member. Consequently, the wire 29 is held and temporarily fixed between the wire temporary-fixing portion 28 and the rod-like member. When the disconnected wire 29 needs to be used, it can be easily removed from a portion between the wire temporary-fixing portion 28 and the rod-like member by pulling the wire upwardly.

In this manner, according to the above embodiment, since the wire temporary-fixing portion 28 capable of temporarily fixing the wire 29 is arranged in the comb-teeth portion 23, the single wire 29 does not disturb the operation. Thus, assembling efficiency of the wire harness can be improved.

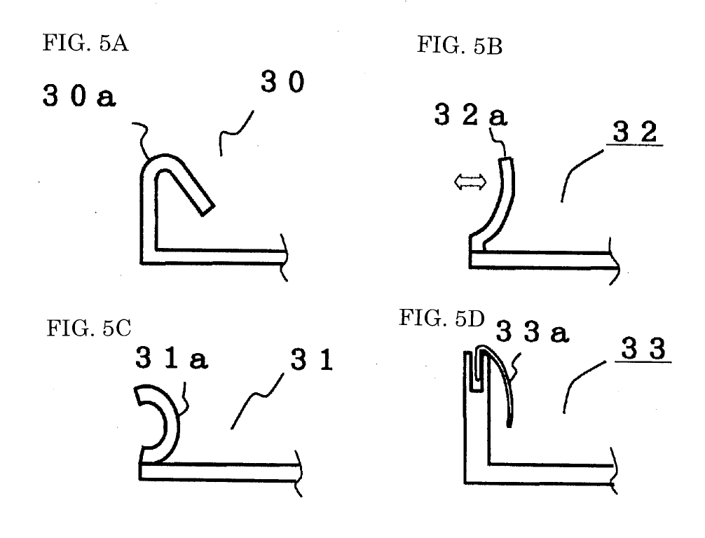

A fourth embodiment shown in FIGS. 5A to 5D relates to a modification example of an elastic member of a connector fixing portion. The embodiment employs various configurations which give spring characteristics to the connector fixing portion.

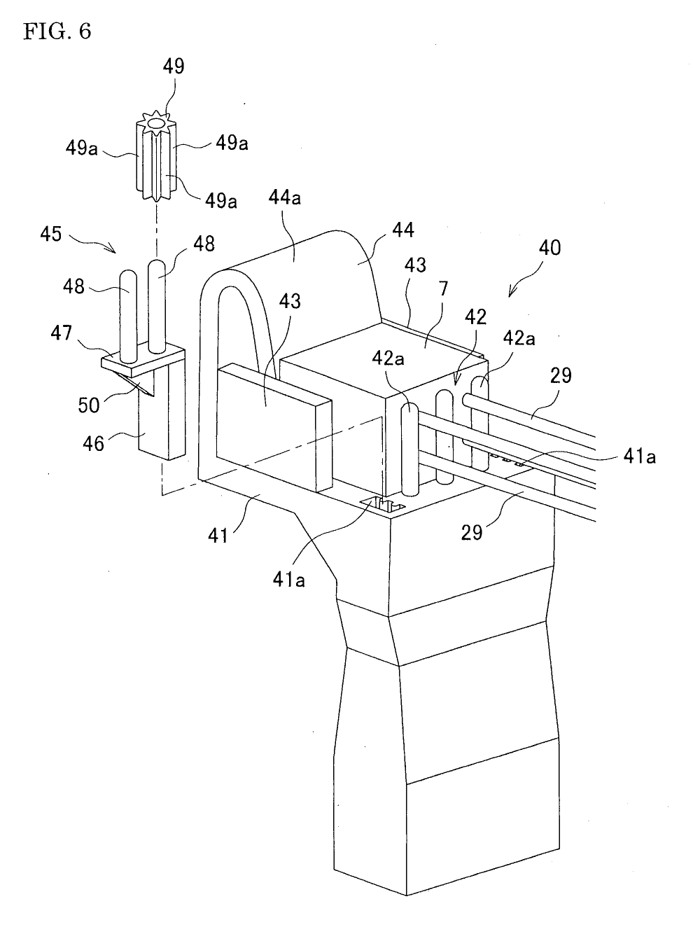

FIG. 5A shows a connector fixing portion 30 having a leaf spring configuration in which an inverted-U-shaped curved portion 30a integrated with the connector fixing portion is provided in order to generate spring characteristics. FIG. 5B shows a connector fixing portion 32 having a snap portion 32a which exhibits spring characteristics. FIG. 5C shows a connector fixing portion 31 having an annular spring configuration where spring characteristics are generated by an annular curved portion 31a. FIG. 5D shows a connector fixing portion 33 having a leaf spring configuration where spring characteristics are generated by a leaf spring member 33a. FIG. 6 shows a fifth embodiment of a terminal connector catch jig 40 in which a plurality of metal pins 42a, 42a . . . , serving as rod-like members of a comb-teeth portion 42, are arranged in front of a placing table 41. On the table 41, the terminal connector 7 is set such that the metal pins 42a are inserted in parallel at predetermined intervals. On both side ends of the placing table 41, side walls 43, 43 serving as regulating portions adjacent to an outer surface of the terminal connector 7 are uprightly arranged in a state where the terminal connector 7 is set. Reference numeral 44 denotes a connector fixing portion, and reference numeral 44a denotes an inverted-U-shaped curved portion.

In the placing table 41, a temporary-fixing unit 45 serving as a wire temporary-fixing portion is attachably and detachably arranged. The temporary-fixing unit 45 includes inserting portions 46 to be inserted into insertion holes 41a, 41a concavely arranged on both sides of the comb-teeth portion 42 on the placing table 41, a rectangular base portion 47 formed on the upper portion of the inserting portion 46, one pair of temporary-fixing pins 48, 48 uprightly arranged on the rectangular base portion 47 at predetermined intervals, and an elastic roller 49 externally covering one of the temporary-fixing pins 48. When the inserting portion 46 is inserted into one of the selected insertion holes 41a, the temporary-fixing pins 48, 48 are straightly aligned at the same intervals as those of the metal pins 42a of the comb-teeth portion 42 in a tangential view. Reference numeral 50 denotes a triangular contact piece projecting from a lower surface of the base portion 47.

When the inserting portion 46 is inserted into the insertion hole 41a, a side edge of the contact piece 50 is brought into contact with a side surface of the terminal connector catch jig 40, so that the base portion 47 projecting to a side of the placing table 41 is horizontally held.

The elastic roller 49 is made of rubber and has a plurality of ridges 49a, 49a which radially projecting at equal intervals to be in an asteroid shape. When the elastic roller 49 externally covers the temporary-fixing pin 48, a leading end of the ridge 49a comes adjacent the temporary-fixing pin 48. At that time, an interval slightly smaller than the diameter of the wire 29 connected to the terminal connector 7 is formed.

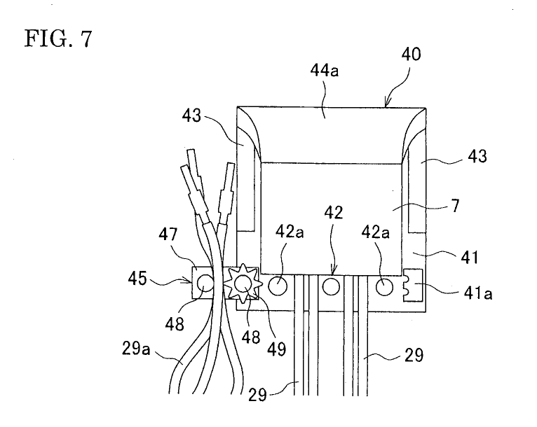

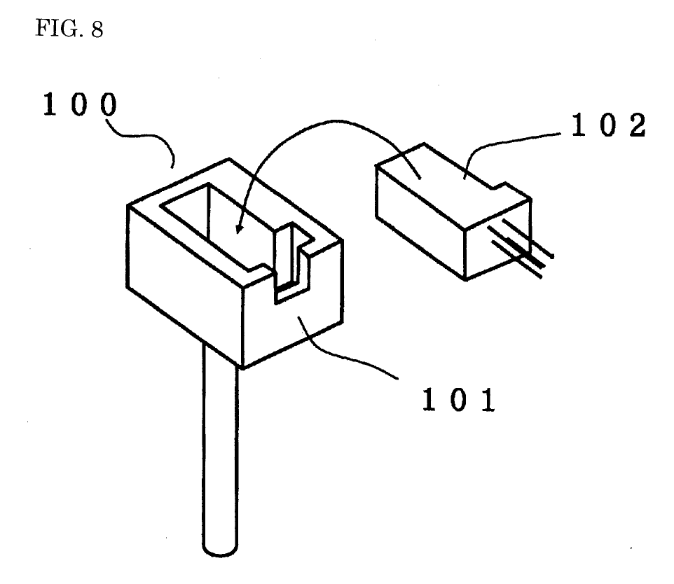

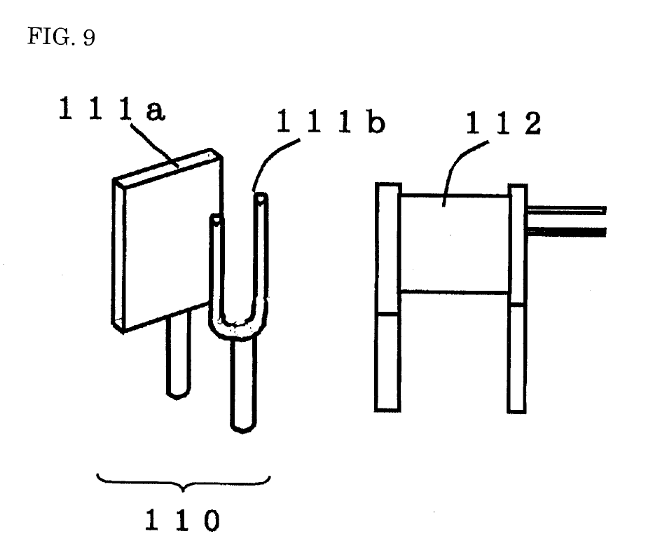

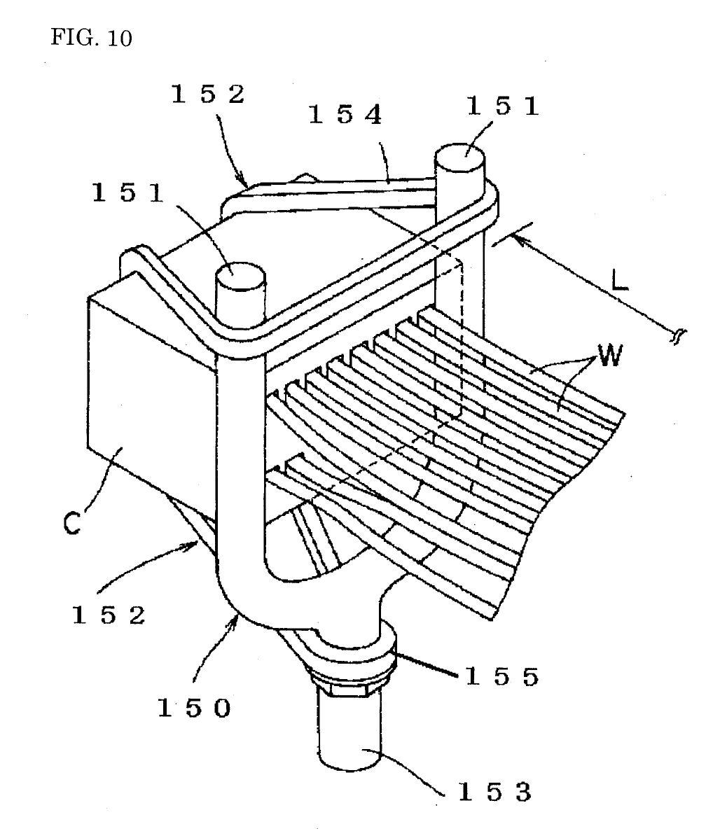

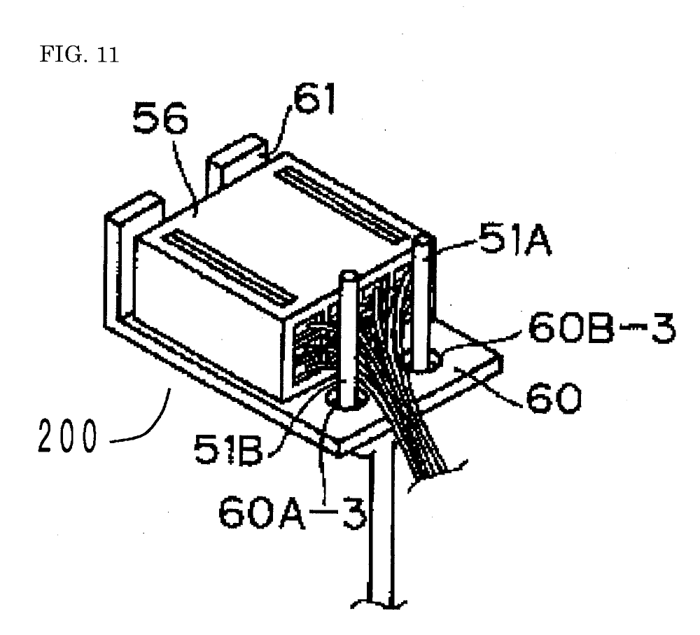

Therefore, when the terminal connector 7 is set on the placing table 41 in the terminal connector catch jig 40 of this embodiment, the side walls 43, 43 are positioned on the both sides of the terminal connector 7 to regulate horizontal movement, as shown in FIG. 7. On the other hand, when some wires are not connected to the terminal connector 7, insulating-coated parts of the not connected wires 29a are inserted between the temporary-fixing portion 48 and the elastic roller 49 from above in the temporary-fixing unit 45 as shown in FIG. 7. As a result, the wires 29a are elastically held between the temporary-fixing portion 48 and the elastic roller 49 and temporarily fixed outside the comb-teeth portion 42. Therefore, the wires 29a do not disturb the wire harness assembling operation. When the wires 29a need to be used, they can be easily removed from a portion between the temporary-fixing portion 48 and the elastic roller 49 by pulling upwardly.

In this manner, according to this embodiment, since the temporary-fixing unit 45 in which one wire 29a or the plurality of wires 29a can be temporarily fixed is arranged adjacent to the comb-teeth portion 42, a wire(s) 29a does not disturb the operation, which improves wire harness assembling efficiency.

Since the temporary-fixing unit 45 is attachably and detachably disposed, the unit 45 can be used only when it is needed, which improves usability. In particular, the temporary-fixing unit 45 is attachable/detachable to/from selected one of the both sides of the placing table 41 and thus, a side to which the wire 29a is temporarily fixed can be arbitrarily selected according to an operation condition. Further, as the elastic roller 49 is also attachable/detachable to/from the temporary-fixing pins 48 in this embodiment, while the temporary-fixing pins 48 may be kept upright on the placing table and used as a comb-teeth portion in a normal state, it also may be used to be externally covered when wires need to be temporarily fixed.

Furthermore, the temporary-fixing unit 45 is constituted by a plurality of temporary-fixing pins 48 uprightly arranged in parallel to the metal pins 42a of the comb-teeth portion 42 and the elastic roller 49 externally covering one of the temporary-fixing pins 48, so that the wires 29a are elastically held between the temporary-fixing pins 48 and the elastic roller 49. Consequently, the wires 29a can be temporarily fixed and removed easily.

It should be noted that the regulating unit does not need to be the wall member as described in the above embodiment. As long as the regulating unit can regulate horizontal misalignment of the terminal connector, the regulating unit may be arbitrarily changed in design, for example, one or more rod-like members or projections may be uprightly formed on both sides of the placing table.

The wire temporary-fixing portion is not limited to an attachable/detachable structure such as the above temporary-fixing unit. As in the embodiment in FIG. 4, temporary-fixing pins may be integrally uprightly arranged on the placing table, or the number of temporary-fixing pins may be increased so as to increase the number of wire temporary-fixing positions. Similarly, the elastic roller is not limited to be attachable/detachable to/from the temporary-fixing pin. The elastic roller may integrally externally cover the temporary-fixing pint, or elastic rollers may cover each of the plurality of temporary-fixing pins respectively. As a matter of course, the shape of the elastic roller is not limited to the above asteroid shape with ridges. The elastic roller can employ another shape such as a simple circular axial section as long as the wire can be held. However, when the shape uniformed in radial directions is applied, the an isotropy of the elastic roller is eliminated. For this reason, it is not necessary to consider the direction of the elastic roller when the elastic roller externally covers the temporary-fixing pin, which makes elastic roller assembly easier.

Furthermore, the wire is not limited to be held between the temporary-fixing pin and the elastic roller. Elastic rollers may externally cover a plurality of temporary-fixing pins respectively, to elastically hold the wire between the elastic rollers.

Embodiments of the present invention are not limited to be above-mentioned embodiments. A method in which a terminal connector is inserted from above into a terminal connector catch jig and fixed by a spring portion constituted by a connector fixing portion and a comb-teeth portion, and a method in which, after a terminal connector is arranged at a predetermined position on a placing table, the terminal connector is held by a connector fixing portion having spring characteristics can be also employed.

What is claimed is:

1. A terminal connector catch jig which fixes a terminal connector included in a wire harness terminal, comprising:
a placing table on which the terminal connector is to be set;
a comb-teeth portion disposed on the placing table in opposition to a connection surface of a wire in the terminal connector, the comb-teeth portion being constituted by a plurality of rod-like members uprightly arranged at intervals in which the wire can be inserted into the comb-teeth portion; and
a connector fixing portion disposed on the placing table to fix the terminal connector together with the comb-teeth portion.

2. The terminal connector catch jig according to claim 1, wherein
the comb-teeth portion and the connector fixing portion are integrally formed on the placing table.

3. The terminal connector catch jig according to claim 1, wherein
the connector fixing portion has a configuration where an elastic member which elastically presses the terminal connector on the placing table to a comb-teeth portion side.

4. The terminal connector catch jig according to claim 2, wherein
the connector fixing portion has a configuration where an elastic member which elastically presses the terminal connector on the placing table to a comb-teeth portion side.

5. The terminal connector catch jig according to claim 3, wherein
the elastic member is an inverted-U-shaped curved portion.

6. The terminal connector catch jig according to claim 4, wherein
the elastic member is an inverted-U-shaped curved portion.

7. The terminal connector catch jig according to claim 1, wherein
a regulating portion which regulates lateral misalignments of the terminal connector set on the placing plate with respect to the comb-teeth portion is arranged on the placing table.

8. The terminal connector catch jig according to claim 1, wherein
a wire temporary-fixing portion which can temporary fix one wire or a plurality of wires is arranged in the comb-teeth portion or adjacent to the comb-teeth portion.

9. The terminal connector catch jig according to claim 8, wherein
the wire temporary-fixing portion is attachably and detachably arranged.

10. The terminal connector catch jig according to claim 8, wherein
the wire temporary-fixing portion is constituted by a plurality of temporary-fixing pins uprightly arranged in parallel to the rod-like members of the comb-teeth portion and an elastic roller externally covering one temporary-fixing pin or a plurality of temporary-fixing pins to temporary fix the wire such that the wire is elastically held between the temporary-fixing pin and the elastic roller or between the plurality of elastic rollers.

11. A method for fixing a terminal connector in the terminal connector catch jig according to claim 1, comprising the steps of:
disposing the terminal connector included in the wire harness terminal between the comb-teeth portion and the connector fixing portion from above the placing plate in a state where a connection surface of the wire faces to a side of the comb-teeth portion; and
holding and fixing the terminal connector between the comb-teeth portion and the connector fixing portion.

12. A method for assembling the wire harness in the terminal connector catch jig according to claim 1, comprising the steps of:
disposing the terminal connector terminal between the comb-teeth portion and the connector fixing portion from above the placing plate in a state where a connection surface of the wire faces to a side of the comb-teeth portion;
holding and fixing the terminal connector between the comb-teeth portion and the connector fixing portion; and
regulating a position of the wire harness.
